(19) United States
(12) Patent Application Publication
(10) Pub. No.: US 2022/0302788 A1
(43) Pub. Date: Sep. 22, 2022

(54) STATOR AND METHOD OF MANUFACTURING STATOR

(71) Applicant: HONDA MOTOR CO., LTD., Tokyo (JP)

(72) Inventor: Norihiko HIKIMA, Tokyo (JP)

(21) Appl. No.: 17/676,844

(22) Filed: Feb. 22, 2022

(30) Foreign Application Priority Data
Mar. 17, 2021 (JP) 2021-043581

(51) Int. Cl. H02K 3/34; H02K 15/10

(52) U.S. Cl. CPC H02K 3/345; H02K 15/10

(57) ABSTRACT

A stator includes a stator core having a plurality of slots and a coil to be inserted into the slots with an insulating paper interposed between the plurality of slots and the coil. The insulating paper includes a folded article in which a base paper having an arc-shaped curling is folded along a folding line extending in the direction with curvature so that the concave surface side of the base paper corresponds to a back surface, and the insulating paper includes curling such that an opening side of the insulating paper opens outwards.

This application is based on and claims the benefit of priority from Japanese Patent Application No. 2021-043581, filed on 17 Mar. 2021, the content of which is incorporated herein by reference.

### BACKGROUND OF THE INVENTION

### Field of the Invention

The present invention relates to a stator and a method of manufacturing a stator.

### Related Art

An insulating paper is inserted for insulation between a coil and a stator core within a slot of a stator core. An insulating paper is shaped by folding and forming a base paper. Normally, the base paper is wound in a roll shape and is used by cutting into a predetermined length while rewinding the base paper.

In general, a base paper wound in the form of a roll has curling. When an insulating paper is folded and formed by a base paper with curling, an inward warping, which an insulating paper warps inward in a slot due to the curling, is generated. This may inhibit the insertion of a coil into a slot. Therefore, when an insulating paper is folded and formed from a base paper, it is necessary to fold an insulating paper to eliminate the curling.

Conventionally, it has been known to manufacture a stator by cutting both ends in a roll width direction into a predetermined length in a state of cuff folding on an outer surface side of a roll while rewinding a base paper of an insulating paper wound in a roll shape, folding the cut base paper along a fold line in a roll width direction in a direction opposite to the cuff folding direction to form an insulating paper, inserting the insulating paper into a slot, and then inserting a coil into the inner side of the insulating paper (for example, see Patent Document 1).
Patent Document 1: Japanese Patent No. 5754349

### SUMMARY OF THE INVENTION

However, there is a problem in that the conventional method requires a cuff folding process for a base paper of an insulating paper to remove curling, making a formation process of an insulating paper complicated.

The present invention has an object to provide a stator having a high working efficiency of a coil insertion work, which can prevent the inward warping of an insulating paper in a slot, by effectively utilizing the curling of an Insulating paper and can smoothly insert a coil into a slot, and a method of manufacturing the stator.

(1) A stator (for example, a stator 1 described later) according to the present invention includes: a stator core (for example, a stator core 2 described later) having a plurality of slots (for example, slots 23 described later); and a coil (for example, a coil 3 described later) to be inserted into the plurality of slots with an insulating paper (for example, an insulating paper 4 described later) Interposed between each of the plurality of slots and the coil, in which the insulating paper includes a folded article in which a base paper having an arc-shaped curling (for example, a base paper 101 described later) is folded along folding lines (for example, folding lines L described later) extending in a direction (for example, a D direction described later) with a curvature so that a concave surface side (for example, a concave surface 101a described later) of the base paper corresponds to a back surface, and the insulating paper includes curling such that an opening side of the insulating paper opens outwards (for example, outwards E described later).

(2) The stator of the above described (1), wherein the plurality of slots each may include a taper part (taper parts 23d described later) that expands an opening width on an opening part (for example, an opening part 23a described later) opening in the radial direction of the stator, and in which the insulating paper may include an outward folding part, (for example, outward folding parts 43 described later) which is folded outwards along each of the taper parts on tip parts (for example, tip parts 4b described later) on the opening side.

(3) The stator of the above (1) or (2), wherein both end parts of the insulating paper along an axial direction of the stator may be protruded respectively from an end surface (for example, an end surface 2a described later) in an axial direction of the stator.

(4) A method of manufacturing a stator according to the present invention is a method of manufacturing a stator (for example, a stator 1 described later) including a stator core (for example, a stator core 2 described later) having a plurality of slots (for example, slots 23 described later) and a coil (for example, a coil 3 described later) to be inserted into the plurality of slots with an insulating paper (for example, an insulating paper 4 described later) interposed between each of the plurality of slots and the coil. The manufacturing method includes an insulating paper folding process of forming the insulating paper by folding a base paper having an arc-shaped curling (for example, a base paper 101 described later) along a folding line (for example, folding lines L described later) extending in a direction (for example, a D direction described later) with curvature so that a concave surface side (for example, a concave surface 101a described later) of the base paper corresponds to a back surface, an insulating paper insertion process of inserting the insulating paper into the plurality of slots prior to inserting the coil to the plurality of slots, and a coil insertion process of inserting the coil from the opening side of the insulating paper in the insulating paper within the plurality of slots.

With the above (1), the insulating paper includes a folded article in which a base paper having an arc-shaped curling is folded along a folding line extending in the direction with curvature so that a concave surface side of the base paper corresponds to a back surface, and the insulating paper includes curling such that an opening side of the insulating paper opens outwards, whereby the curling is effectively utilized and the insulating paper is self-held along the inner surfaces of the slots. As a result, the inward warping of an insulating paper in a slot can be prevented, and a stator having a high working efficiency of a coil insertion work capable of smoothly inserting a coil into a slot, can be provided.

With the above (2), outward folding parts of an insulating paper along the taper parts of a slot can prevent a catch between a coil and an insulating paper due to variations in shapes of insulating papers when inserting the coil. Thus, this makes a smooth insertion of a coil into a slot, leading to further improved work efficiency of the insertion work of a coil.

With the above (3), insulation from the coil at an edge in an axial direction of a slot is easily made possible without a cuff folding of an insulating paper.

With the above (4), an arc-shaped curling of a base paper of an insulating paper is effectively utilized, and the insulating paper is self-held along the inner surface of a slot. Thereby, the inward warping of an insulating paper in a slot can be prevented. It is also possible to manufacture a stator having a high working efficiency for the insertion work of a coil with ease and capable of smoothly inserting a coil into a slot.

### BRIEF DESCRIPTION OF THE DRAWINGS

FIG. 1 shows a perspective view of a stator according to one embodiment of the present invention;

FIG. 2 shows a plane view Illustrating a stator core of a stator in FIG. 1;

FIG. 3 is a perspective view of insulating papers into a part of the slots of a stator core in FIG. 2;

FIG. A is a front view of a coil before mounting on a stator;

FIG. 5 is a view illustrating an insulating paper manufacturing process;

FIG. 6 is a view showing an insulating paper manufacturing process;

FIG. 7 is a plane view of an insulating paper;

FIG. 8 illustrates how a coil is inserted into a slot where an insulating paper is inserted;

FIG. 9 is a plane view showing a part of a stator core of a stator according to another embodiment of the present invention;

FIG. 10 is a plane view of an insulating paper inserted into a slot of a stator core shown in FIG. 9; and

FIG. 11 illustrates how a coil is inserted into the slot where the insulating paper is inserted in FIG. 10.

### DETAILED DESCRIPTION OF THE INVENTION

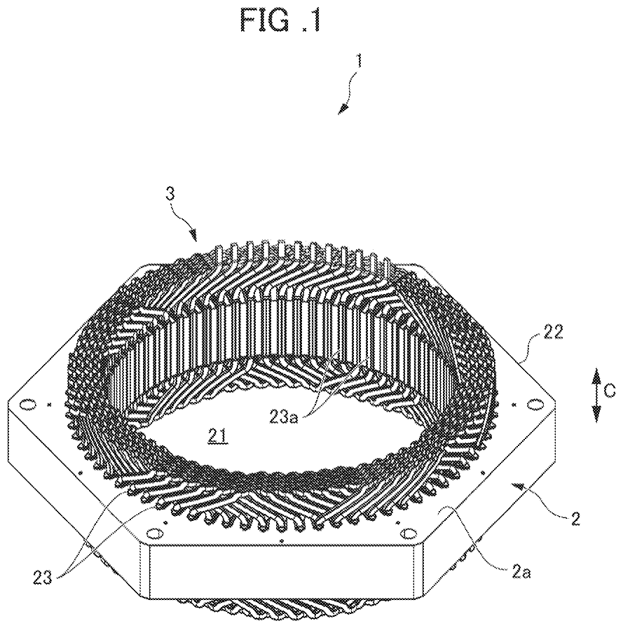

Hereinafter, embodiments of the present invention are described in detail with reference to the accompanying drawings. As shown in FIG. 1, a stator 1 of this embodiment includes a stator core 2 and a coil 3 mounted on the stator core 2 in an annular shape.

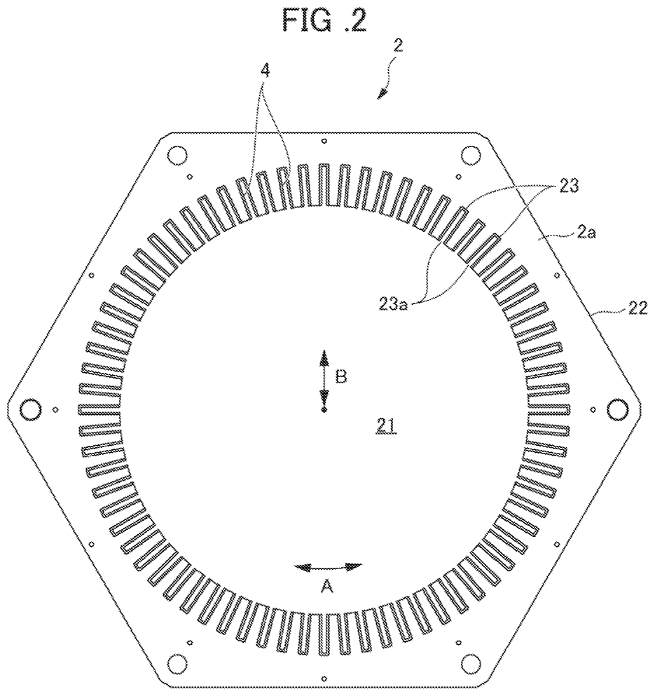

The stator core 2, as shown in FIG. 2, includes a round shaft hole 21 in the center of the stator core and, for example, an annular part 22 including a laminate formed by laminating a plurality of thin core plates. The annular part 22 includes a plurality of slots 23 penetrating in the axial direction of the stator core 2. The slots 23 are radially arranged at fixed intervals along the circumferential direction of the stator core 2 and includes opening parts 23a which open toward the radially inner shaft hole 21 of the annular part 22. The stator core 2 of this embodiment includes 72 slots 23. Note that in the stator 1 and the stator core 2, as shown in FIG. 2, an A direction in which the slots 23 are arranged is a circumferential direction, a B direction along the radiation direction from the center of the shaft hole 21 is a radial direction, and a C direction (a vertical direction to the paper surface in FIG. 2) shown in FIG. 1 is an axial direction.

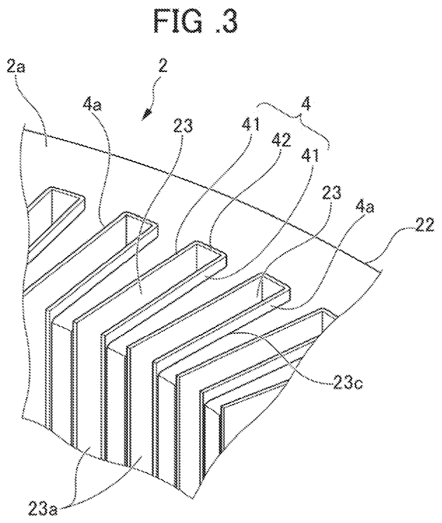

As shown in FIGS. 2 and 3, insulating papers 4 are inserted into each of the slots 23 of the stator core 2. The insulating paper 4 is a folded article that is folded into a U shape with corners so as to follow an approximately U-shaped inner shape of the slot 23 when the stator core 2 is viewed from the axial direction. In other words, the insulating paper 4 includes a pair of radial direction parts 41, 41 along the inner surface of the slot 23 extending in the radial direction of the stator core 2 and a circumferential direction part 42 connecting the radially outer end parts of the radial direction parts 41, 41 along the circumferential direction of the stator core 2.

The insulating paper 4 inserted into the slot 23 includes a cuff part 4a. The cuff part 4a is a part where the radial direction parts 41, 41 and the circumferential direction part 42 of the insulating paper 4 are extended in the axial direction of the stator core 2 and protruded from the slot 23 and is a projected part outward from an end surface 2a in the axial direction of the stator core 2. Although FIG. 3 shows only one of the cuff parts 4a of the insulating paper 4 protruding from one of the end surfaces 2a of the stator core 2, the cuff parts 4a are protruded from both end surfaces 2a, 2a in the axial direction of the stator core 2, respectively.

As shown in FIG. 4, the coil 3 mounted on the stator core 2 in an annular shape, is a long belt-shaped coil formed by a flat conductor wire 31 with an approximately rectangular cross-sectional shape. The flat conductor wire 31 is formed of a high conductive metal, for example, copper, aluminum or the like.

The coil 3 includes a plurality of straight parts 32 and a plurality of coil end parts 33. The straight parts 32 are the parts that are inserted into the slots 23 of the stator core 2, each extending in an approximately straight line and arranged in parallel at fixed intervals. The coil end parts 33 are arranged at positions closer to the side ends of the coil 3 than the straight parts 32 and alternately connects one end parts and the other end parts of the straight parts 32 that are adjacent to each other in a mountain shape. The coil end parts 33 are parts arranged so as to project respectively from the slots 23 in the axial direction of the stator core 2 when the coil 3 is mounted on the slots 23 of the stator core 2. In this embodiment, the coil 3 is formed in a long belt shape in such a way that the six flat conductor wires 31 formed by folding a plurality of straight, parts 32 and a plurality of coil end parts 33, respectively, are bundled so that the straight parts 32 are parallel at fixed intervals.

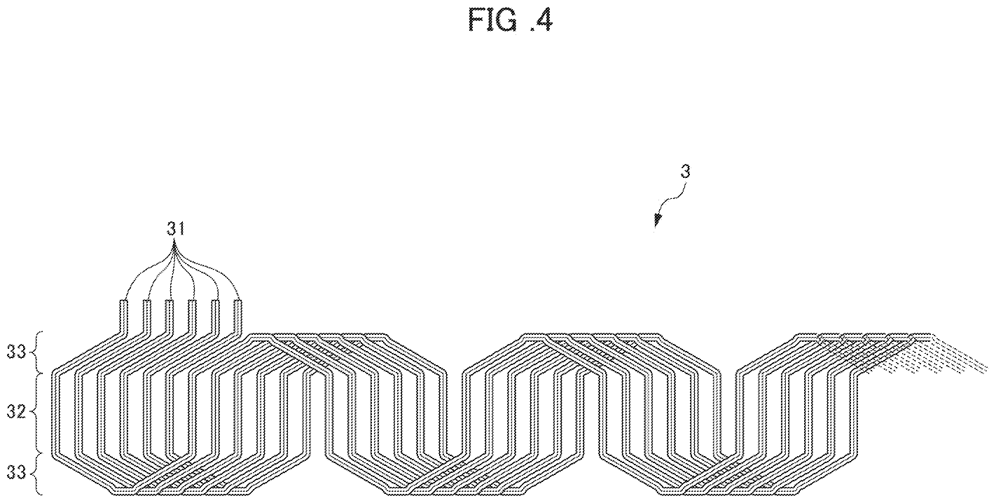

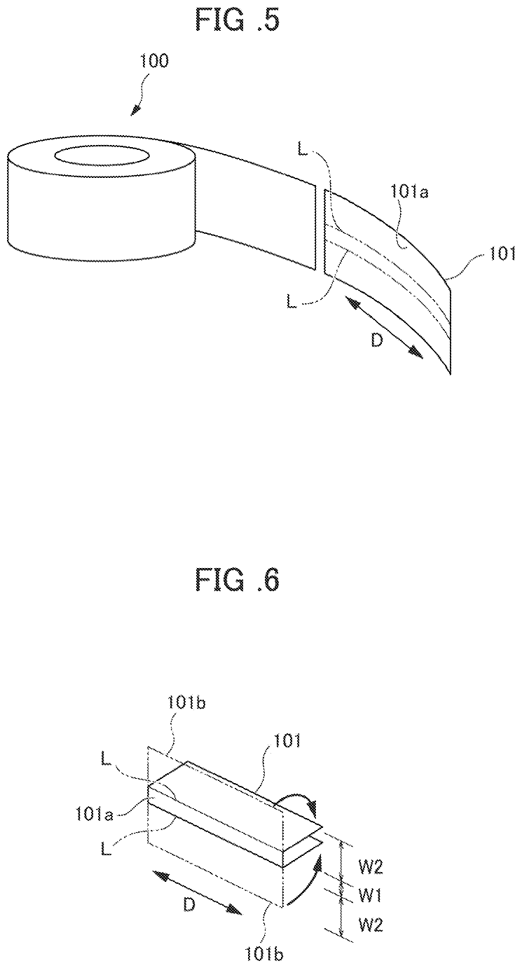

Next, the manufacturing method of the stator 1 is described with reference to FIGS. 5 to 8. First, with reference to FIGS. 5 to 7, the insulating paper 4 is described in more detail. As shown in FIGS. 5 and 6, the insulating paper 4 is formed by folding a base paper 101 with a rectangular shape into a U shape. The base paper 101 is formed by being rewound from a base paper roll 100 wound in a roll shape and cut to a predetermined length.

As shown in FIG. 5, the base paper 101 has curling of curving into an arc shape due to the previously wounded into a roll shape. The curling occurs in a direction along the winding direction of the roll shape. A concave surface 101a on the arc-shaped base paper 101 is a surface arranged on the inner surface side when the base paper 101 is wound around the base paper roll 100 (a surface arranged on the inner side in the radial, direction of the base paper roll 100). In FIGS. 5 and 6, a D direction shows a direction in which an arc-shaped curling has a curvature. This D direction is along the direction at which the base paper 101 is rewound from the base paper roll 100. The D direction is also a direction along the axial direction of the slot 23 when the insulating paper 4 is inserted into the slot 23. The length along the D direction of the cut one piece of base paper 101 is longer than the length along the axial direction of the slot 23.

The base paper 101 is folded into a U shape along a pair of folding lines L, L so as to follow the inner surface shape of the slot 23 so that the concave surface 101a side of the curling is a back surface (an insulating paper folding process).

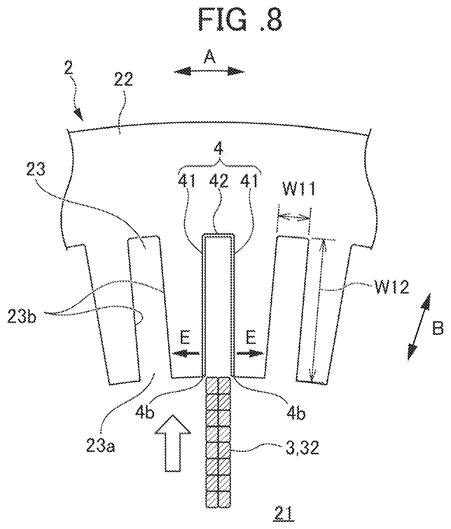

More specifically, as shown in FIG. 6, outer end parts 101b, 101b of the pair of folding lines L, L of the base paper 101 are respectively folded toward the opposite side of the concave surface 101a. The pair of folding lines L, L extend in parallel along a direction having a curvature in the base paper 101 with an arc-shaped curling. An interval W1 of the pair of folding lines L, L is substantially equal to a width W11 (see FIG. 8) in the circumferential direction of the slot 23. Lengths W2, W2 from the folding lines L, L of the outer end parts 101b, 101b are substantially equal to a radial direction depth W12 (see FIG. 8) of the slot 23.

Note that the folding lines L, L may be lines virtually set on the base paper 101 when the base paper. 101 is folded. Further, the folding lines L, L serve as a reference for the position at which the base paper 101 is folded and need not necessarily be folded so that the base paper 101 forms clear fold lines along the folding lines L, L.

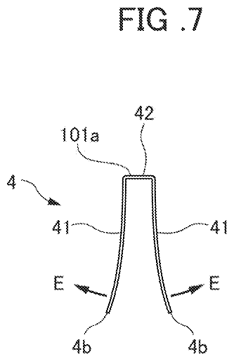

By folding the base paper 101 as described above, as shown in FIG. 7, a U-shaped insulating paper 4 is formed. The pair of outer end parts 101b, 101b folded by the folding lines L, L constitute the radial direction parts 41, 41 of the insulating paper 4. The circumferential direction part 42 of the insulating paper 4 is formed between the folding line L and the folding line L. The U-shaped insulating paper 4 includes the tip parts of the pair of radial direction parts 41, 41 (the side opposite to the circumferential direction part 42) has a shape that opens.

Since the insulating paper 4 is folded so that the concave surface 101a side with the arc-shaped curling is a back surface, a force to warp toward the opposite sides to the folded sides of the radial direction parts 41, 41 along the D direction by the circumferential direction part 42, which is a back surface, is exerted due to the arc-shaped curling. As a result, the insulating paper 4 has the tendency to open outwards E, E, in which the pair of radial direction parts 41, 41 are oppose to each other. The outwards E are directions along the circumferential direction of the stator core 2.

Next, as shown in FIG. 3, prior to an insertion of the coil 3 into the slots 23, the insulating papers 4 are inserted into each of the slots 23 (an insulating paper insertion process). The insulating paper 4 is inserted from the radially inner side toward the outside with respect to the slot 23, starting from the circumferential direction part 42 side of the insulating paper 4, so that the opening side is arranged on the opening part 23a side of the slot 23. The positions of radially inner tip parts 4b, 4b of the insulating paper 4 inserted into the slot 23 substantially coincide with the position of the opening part 23a of the slot 23. Since the insulating paper 4 in the slot 23 has the tendency to open outwards E, E, in which the pair of radial direction parts 41, 41 are oppose to each other, the radial direction parts 41, 41 of the insulating paper 4 are in close contact with the inner surfaces 23b, 23b extending in the radial direction of the slot 23. This allows for the self-held of the insulating paper 4 within the slot 23 and preventing the insulating paper 4 from warping inward in the slot 23.

Since the length of the base paper 101 along the D direction is longer than the length along the axial direction of the slot 23,

the insulating paper 4 inserted into the slot 23, as shown in FIG. 3, has the cuff parts 4a protruding from the end surface 2a in the axial direction of the stator core 2. The cuff parts 4a are not cuff folded parts as in the prior art but are parts in which the radial direction parts 41, 41 and the ends of the circumferential direction part 42 of the insulating paper 4 are extended as they are. Therefore, the insulating paper 4 can easily insulate from the coil 3 at an edge 23c (see FIG. 3) in the axial direction of the slot 23.

After the insulating paper 4 is inserted into the slot 23, the straight part 32 of the coil 3 is inserted into the inside of the insulating paper 4 in the slot 23 from the opening side of the insulating paper 4 (a coil insertion process). Although not shown, the coil 3 is previously wound in an annular shape having a smaller diameter than the shaft hole 21 of the stator core 2 and inserted Into the shaft hole 21. The straight part 32 is inserted into the insulating paper 4 through the opening part 23a of the slot 23 by expanding the diameter of the annular coil 3 in the shaft hole 21 toward the outside in the radial direction. At this time, since the radial direction parts 41, 41 of the insulating paper 4 in the slot 23 are arranged so as to be in close contact with the inner surfaces 23b, 23b of the slot 23 due to the opening tendency of the outwards E, E originating from the arc-shaped curling of the base paper 101, the insertion of the straight part 32 is not prevented by the insulating paper 4 and the straight part 32 being caught. This makes it possible to smoothly insert the straight part 32 of the coil 3 into the slot 23, thereby improving the work efficiency of the coil insertion. Thereafter, all of the straight parts 32 of the coil 3 are Inserted into the slots 23, the stator 1 shown in FIG. 1 is completed.

As described above, the stator 1 in this embodiment includes the stator core 2 having a plurality of slots 23 and the coil 3 to be inserted into the slots 23 with the insulating paper 4 interposed therebetween. The insulating paper 4 is formed of a folded article that is folded into a U shape along the folding lines L, L extending in the direction D having a curvature following the inner surface shape of the slot 23 so that the concave surface 101a side of the base paper 101 having an arc-shaped curling is a back surface and includes curling such that the opening side that opens outwards E, E. With this, the insulating paper 4 can effectively utilize an arc-shaped curling of the base paper 101 and is self-held along the inner surfaces 23b, 23b of the slot 23. Therefore, the inner warping of the insulating paper 4 in the slot 23 can be prevented. It is also possible to provide the stator 1 with a high working efficiency of the coil insertion in which the straight part 32 of the coil 3 can be smoothly inserted into the slot 23.

Both end parts of the insulating paper. 4 along the axial direction of the stator core 2 in this embodiment are protruded respectively from the end surfaces 2a in the axial direction of the stator core 2. With this, insulation from the coil 3 at the edge 23c in the axial direction of the slot 23 is easily made possible without a cuff folding of the insulating paper 4.

In addition, a manufacturing method of the stator 1 in this embodiment is a manufacturing method of the stator 1 including the stator core 2 with a plurality of the slots 23 and the coil 3 to be inserted into the slots 23 with the insulating paper 4 interposed therebetween. The manufacturing method includes an insulating paper folding process for forming the insulating paper 4 by folding a base paper 101 having an arc-shaped curling into a U shape along the folding lines L, L extending in the direction D having a curvature following the inner surface shape of the slot 23 so that the concave surface 101a side is a back surface, an insulating paper insertion process for inserting the insulating paper 4 into the slot 23 before inserting the straight part 32 of the coil 3 in the slot 23, and a coil insertion process for inserting the straight part 32 of the coil 3 into the inside of the insulating paper 4 in the slot 23 from the opening side of the insulating paper 4. With this, an arc-shaped curling of the base paper 101 of the insulating paper 4 can be effectively utilized and the insulating paper 4 is self-held along the inner surface 23b of the slot 23. Therefore, the inner warping of the insulating paper 4 in the slot 23 can be prevented. It is also possible to easily manufacture the stator 1 with a high working efficiency of the coil insertion in which the straight part 32 of the coil 3 can be smoothly Inserted into the slot 23.

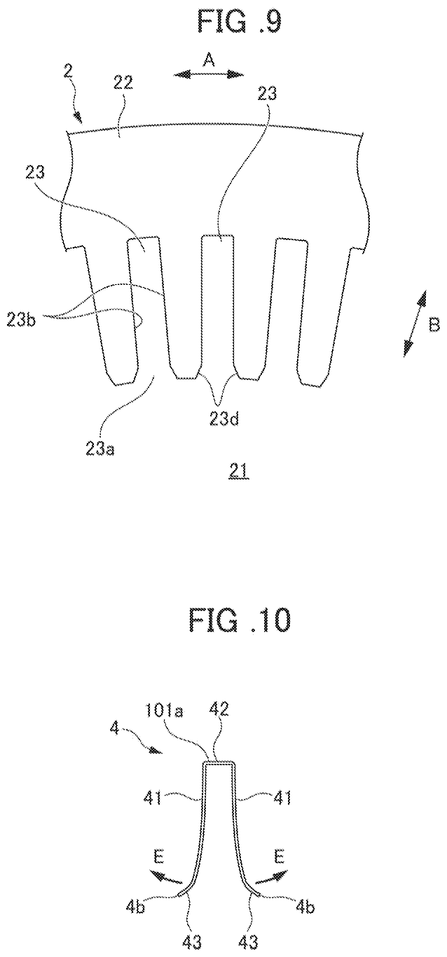

FIGS. 9 to 11 show the stator core 2 of the stator and insulating paper 4 according to another embodiment. The slot 23 of the stator core 2, as shown in FIG. 9, includes taper parts 23d, 23d expanding an opening width on the opening part 23a. In other words, a width along the circumferential direction of the slot 23 is formed so as to be widest in the radially inner opening part 23a.

The insulating paper 4 inserted into the slot 23 of the stator core 2 is formed by being folded from the base paper 101 by a method as shown in FIGS. 5 and 6. However, as shown in FIG. 10, the tip parts 4b, 4b of the opening side, include outward folding parts 43, 43 folded the outwards E, E along the taper parts 23d, 23d of the slot 23, respectively. The outward folding parts 43, 43 are formed by folding the outer side than the pair of folding lines L, L toward the concave surface 101a side along folding lines (not shown) parallel to the folding lines L, L before or after folding the outer end parts 101b, 101b of the pair of folding lines L, L in the base paper 101 shown in FIG. 6.

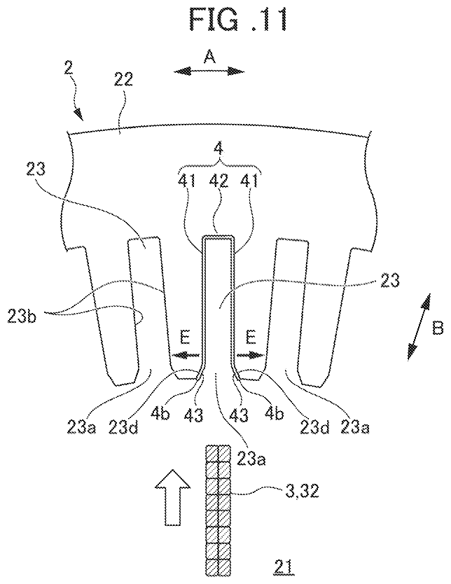

When the insulating paper 4 having the outward folding parts 43, 43 is inserted into the slot 23, as shown in FIG. 11, the outward folding parts 43, 43 are in close contact with the taper parts 23d, 23d of the slot 23 due to an opening tendency in which the radial direction parts 41, 41 of the insulating paper 4 open outwards E, E. Thus, since the insulating paper 4 opens widely toward the shaft hole 21 of the stator core 2, it is possible to prevent a catch between the straight part 32 of the coil 3 and the insulating paper 4 due to variations in shapes of the insulating papers 4 when the straight part 32 of the coil 3 is inserted. Mote that also in this case, the positions of the radially inner tip parts 4b, 4b of the insulating paper 4 inserted into the slot 23 substantially coincide with the position of the opening part 23a of the slots 23.

Thus, the slot 23 of this embodiment, includes the taper part 23d expanding an opening width on the opening part 23a opening in the radial direction of the stator core 2 of the stator 1. The insulating paper 4 includes the outward folding parts 43, 43 folded the outwards E, E along the taper parts 23d, 23d, at the tip parts 4b, 4b on the opening side respectively. As a result, the outward folding parts 43, 43 of the insulating paper 4 along the taper parts 23d, 23d of the slot 23 can prevent a catch between the straight part 32 of the coil 3 and the insulating paper 4 due to variations in shapes of the insulating papers 4 when the straight part 32 of the coil 3 is inserted. Therefore, this makes a smooth insertion of the straight part 32 of the coil 3 into the slot, leading to further improved work efficiency of the insertion work of a coil.

Although the insulating paper 4 is folded into a U shape following the inner shape of the slot 23 when viewed from the axial direction of the stator core 2 in the above embodiment, the shape of the insulating paper 4 is not limited to this and can be changed as needed depending on the inner shape or the like of the slot 23. For example, the insulating paper 4 may be folded in a U shape, a V shape or the like viewed from the axial direction of the stator core 2.

Although the slot 23 of the stator core 2 is provided so as to open to the inner peripheral side in the above embodiment, the slot 23 may be provided so as to open to the outer peripheral side of the stator core 2.

### EXPLANATION OF REFERENCE NUMERALS

1 stator
2 stator core
2a end surface
23 slots
23a opening parts
23d taper parts
3 coil
4 insulating papers
4b tip parts
43 outward folding parts
101 base paper
101a concave surface
D direction having a curvature
E outwards
L folding lines

What is claimed is:

1. A stator comprising a stator core having a plurality of slots, and a coil to be inserted into the plurality of slots with an insulating paper interposed between each of the plurality of slots and the coil,
wherein the insulating paper includes a folded article in which a base paper having an arc-shaped curling is folded along a folding line extending in a direction with a curvature so that a concave surface side of the base paper corresponds to a back surface, and the insulating paper includes curling such that an opening side of the insulating paper opens outwards.

2. The stator according to claim 1,
wherein the plurality of slots each include a taper part that expands an opening width on an opening part opening in a radial direction of the stator core, and
wherein the insulating paper includes an outward folding part which is folded outwards along each of the taper parts on tip parts on the opening side.

3. The stator according to claim 1, wherein both end parts of the insulating paper along an axial direction of the stator core are protruded respectively from end surfaces in an axial direction of the stator core.

4. A method oi: manufacturing a stator Including a stator core having a plurality of slots and a coil to be inserted into the plurality of slots with an insulating paper interposed between each of the plurality of slots and the coil, the manufacturing method comprising:
an insulating paper folding process of forming the insulating paper by folding a base paper having an arc-shaped curling along a folding line extending in a direction with a curvature so that a concave surface side of the base paper corresponds to a back surface;
an insulating paper insertion process of inserting the insulating paper into the plurality of slots prior to inserting the coil into the plurality of slots; and
a coil insertion process of inserting the coil from the opening side of the insulating paper inside the insulating paper within the plurality of slots.
